(19) United States
(12) Patent Application Publication
(10) Pub. No.: US 2024/0357711 A1
(43) Pub. Date: Oct. 24, 2024

(54) FILAMENTED CASK FOR GRAPHITIZATION OF CARBON MATERIAL

(71) Applicant: Graftech International Holdings Inc., Brooklyn Heights, OH (US)

(72) Inventors: Nathanael Henderson May, North Royalton, OH (US); William Eric Slye, Cuyahoga Falls, OH (US); Ryan Michael Paul, Willoughby, OH (US); Andrew Adam Hausner, Chippewa Lake, OH (US); Eric Josef Rauert, Fairview Park, OH (US); Mark Segger, Carleton Place (CA)

(21) Appl. No.: 18/636,486

(22) Filed: Apr. 16, 2024

Related U.S. Application Data
(60) Provisional application No. 63/460,516, filed on Apr. 19, 2023.

(51) Int. Cl. H05B 3/14; B01J 19/08; C01B 32/205; D01F 9/12; H05B 1/02; H05B 3/42; H05B 3/60

(52) U.S. Cl. CPC H05B 3/145; B01J 19/087; C01B 32/205; D01F 9/12; H05B 1/0247; H05B 3/42; H05B 3/60

(57) ABSTRACT

A system for graphitization of carbon powder, the system including a cask comprising a cask body made of a carbonaceous material and a binder, the cask body having a cavity. The system further includes a filament made of a carbonaceous material and a binder, wherein the filament is configured to be positioned in the cavity and aligned with the cask body.

This application claims priority to U.S. Provisional Patent Application Ser. No. 63/460,516, filed on Apr. 19, 2023 and entitled Filamented Cask For Graphitization Of Carbon Material, the entire contents of which are hereby incorporated by reference.

### BACKGROUND

The present disclosure relates to a cask for graphitization of carbon material, and more particularly, to such a cask having a filament.

Graphitization of carbon materials typically involves heating a starting or payload material, such as amorphous carbon, to predetermined temperatures for predetermined periods of time. During the graphitization process the carbon atoms rearrange, resulting in crystal growth and a decrease in interlayer spacing to produce graphite. In some cases the payload material is heated to temperatures of about 2,000° C.-3,000° C., or more, to provide sufficient graphitization.

In an Acheson-type graphitization furnace for graphitizing carbon, the payload material is first positioned in casks. The casks are, in turn, positioned in an electrically conductive packing material, such as loose coke particles. An electric current is passed through the conductive packing material to heat the casks. The casks and payload material are thereby heated by heat radiating from the packing material, in and outside-in manner. However, Acheson graphitization furnaces require long cycle times and high energy usage.

In a longitudinal graphitization furnace or process for graphitizing carbon bodies (also known as a lengthwise graphitization furnace/process), the payload material is loaded into a cask. Electric current is then directed through the cask and/or payload material to heat the payload material to the desired temperature for the desired period of time. However, since the payload material is not particularly electrically conductive, it can be difficult and time consuming to heat the payload material to the desired temperature.

### SUMMARY

In one embodiment, the invention is a system for graphitization of carbon powder, the system including a cask comprising a cask body made of a carbonaceous material and a binder, the cask body having a cavity. The system further includes a filament made of a carbonaceous material and a binder, wherein the filament is configured to be positioned in the cavity and aligned with the cask body.

### BRIEF DESCRIPTION OF THE DRAWINGS

FIG. 1 is a perspective, cross sectional exploded view of a cask with a filament;

FIG. 2 is a front perspective view of a series of casks connected together and positioned in a cradle;

FIG. 3 shows the casks of FIG. 2 positioned in a bed of loose material;

FIG. 4 is a side cross section the cask of FIG. 1, with a payload material positioned therein, and adjacent to two other casks;

FIG. 5 is a circuit diagram representing a flow of current to and through the cask of FIG. 1;

FIG. 6 is a perspective, cross sectional exploded view of another embodiment of a cask with a filament;

FIG. 7 is a side cross section of the cask of FIG. 6, with a payload material positioned therein;

FIG. 8 is a circuit diagram representing a flow of current to and through the cask of FIG. 6;

FIG. 9 is a perspective, cross sectional exploded view of another embodiment of a cask with a filament;

FIG. 10 is a side cross section of the cask of FIG. 9, with a payload material positioned therein;

FIG. 11 is a circuit diagram representing a flow of current to and through the cask of FIG. 10;

FIG. 12 is a side cross section of yet another embodiment of a cask with a filament, with a payload material positioned therein;

FIG. 13 is a circuit diagram representing a flow of current to and through the cask of FIG. 12;

FIG. 14 shows the cask of FIG. 12 adjacent to two other such casks;

FIG. 15 is a side cross section of cask, having a filament with a sub-filament therein;

FIG. 16 is a side cross section of two adjacent casks with a shared plug;

FIG. 17 is a side cross section of a cask with a floating filament;

FIG. 18 is another side cross section of a cask with a floating filament; and

FIG. 19 is another side cross section of a cask with a floating filament.

### DETAILED DESCRIPTION

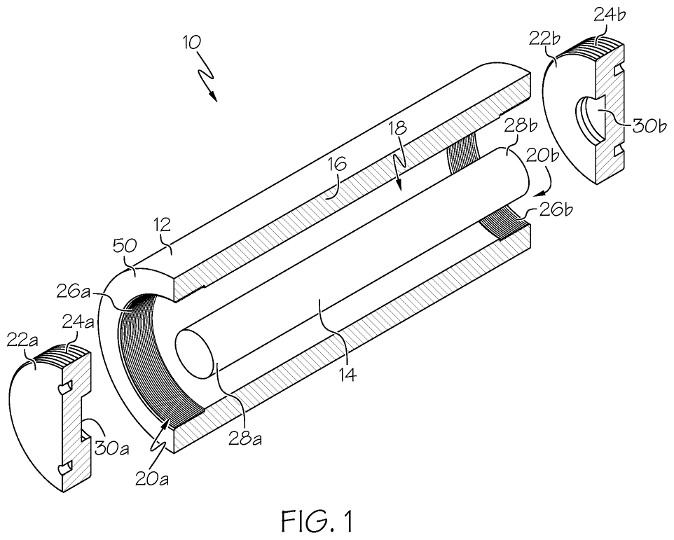

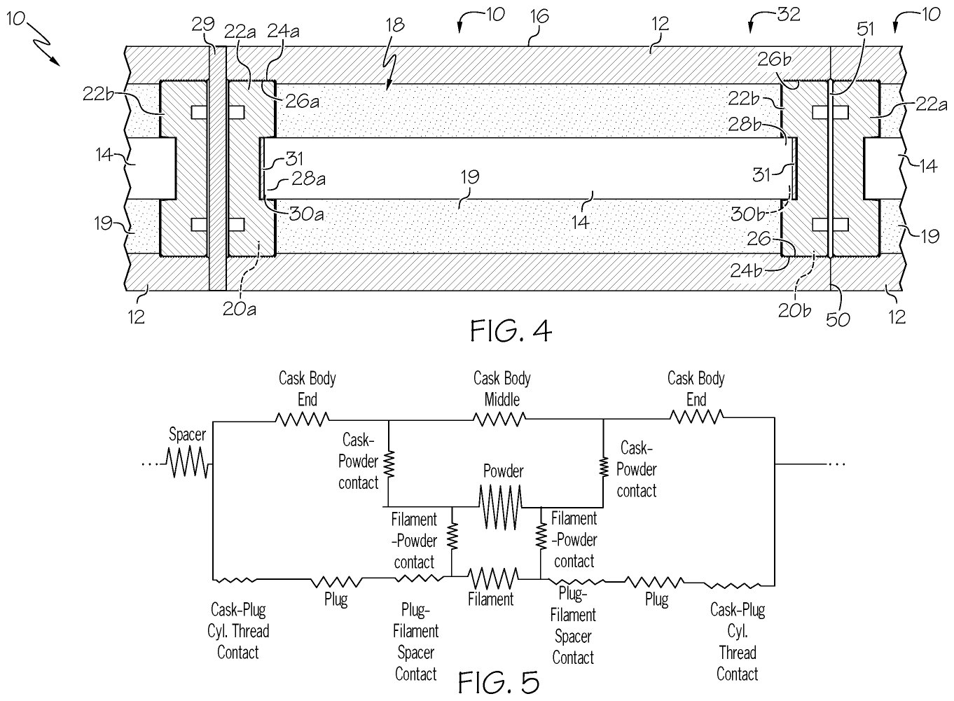

With reference to FIGS. 1 and 4, a cask 10 is shown having a cask body 12 and a filament 14 positioned therein. The cask body 12 can be generally tubular/hollow and is generally cylindrical in the illustrated embodiment, having a circular cross section. However the cask body 12 can have other shapes or profiles, such as for example being generally oval, square, rectangular, or other shapes in cross section. Similarly, the filament 14 can be solid and generally cylindrical as shown, having a circular cross section in the illustrated embodiment. However the filament 14 can have other shapes or profiles, such as for example being generally oval, square, rectangular, or other shapes in cross section. In addition, as will be described in greater detail below, the filament 14 can in some cases itself be hollow with a sub-filament positioned therein.

The cask body 12 and/or filament 14 can be made of the same or similar materials used to form graphite electrodes for electric arc furnaces, and thus in some cases the cask body 12 can be considered a hollow graphite electrode. Accordingly the cask body 12 and/or filament 14 can be a solid material and include carbon and/or be primarily made of carbon by weight and/or volume, and/or be a carbonaceous material, and/or be substantially or primarily made of a graphite such as a graphitized mixture of coke (for example needle coke), calcined petroleum coke, calcined anthracite, and a binder, such as for example pitch, coal tar pitch or petroleum pitch, that is formed, baked, impregnated, graphitized and machined. The cask body 12 and/or filament 14 can be able to accommodate electrical currents densities in excess of 20 A/cm² in one case, or in excess of 30 or 35 A/cm² in another case, while retaining its shape and dimensional properties.

The cask body 12 and/or filament 14 may be able to be heated to temperatures of at least about 2,000° C. in one case, or least about 2,800° C. in another case, or at least about 3,000° C. in another case, or at least about 3200° C. in yet another case while retaining their shape and dimensional properties, and while remaining electrically conductive. U.S. Pat. No. 10,237,928, the entire contents of which are hereby incorporated by reference, discloses electrodes and methods for making such electrodes, which materials and methods can be used to make the cask body 12 and/or filament 14 described herein.

The cask body 12 can include a sidewall 16 defining an inner cavity 18 and a pair of opposed open ends 20a, 20b. The cask 10 can have a pair of plugs 22a, 22b, where each plug 22a, 22b is configured to be coupled to the cask body 12 and to cover an associated open end 20a, 20b. In particular, in the illustrated embodiment each plug 22a, 22b is a generally cylindrical component with a threaded outer surface 24a, 24b that is configured to be threaded into a corresponding threaded inner surface 26a, 26b located at each open end 20a, 20b of the cask body 12. Each plug 22a, 22b can be made of the same material as the cask body 12 and/or filament 14 as described above.

The filament 14 can include a pair of opposed ends 28a, 28b, and each plug 22a, 22b can be configured to engage an associated end 28a, 28b of the filament 14, so as to suspend the filament 14 concentrically inside the cask body 12. In particular, each plug 22a, 22b can have a plug recess 30a, 30b configured to closely receive the associated end 28a, 28b of the filament 14 therein. In this manner the filament 14 can extend the entire or substantially the entire length of the cask body 12 (e.g. at least about 80% of a length of the cask body 12 in one case, or at least about 90% of the length of the cask body 12 in another case, or at least about 95% of the length of the cask body 12 in yet another case), and can be entirely spaced away from the sidewall 16 of the cask body 12 along a length of the filament 14, and suspended therein in one case.

Thus in some cases, when the cask 10 is empty as shown in FIG. 1, there is no material or component (except the plugs 22a, 22b, located at the axial ends of the cask body 12) extending from the sidewall 16 of the cask body 12 to the filament 14 in the radial direction, which can maximize use of the space of the inner cavity 18 inside the cask body 12, enables the filament 14 to relatively freely expand/contract along its axial length to reduce thermal stress, and control the flow of current to/from the filament 14. Thus the filament 14 can be a separate/separable component from the cask body 12 that is removable therefrom (without causing damage or breakage of the cask body 12 or any parts thereof) for inspection, repair and/or replacement.

The filament 14 can be relatively small to ensure sufficient space for receipt of the powder/payload material 19 in the inner cavity 18. The filament 14 can in one case take up less than 40%, an in another case less than 20%, of the volume of the inner cavity 18, and in another case take up more than 1%, and in another case more than 5%, of the volume of the inner cavity 18. In one case the filament 14 does not extend through or axially beyond an axial end surface of the cask body 12, and does not extend through or axially beyond each plug 22a, 22b, and instead the filament 14 is entirely positioned within/contained by the cask body 12 and entirely positioned in the inner cavity 18.

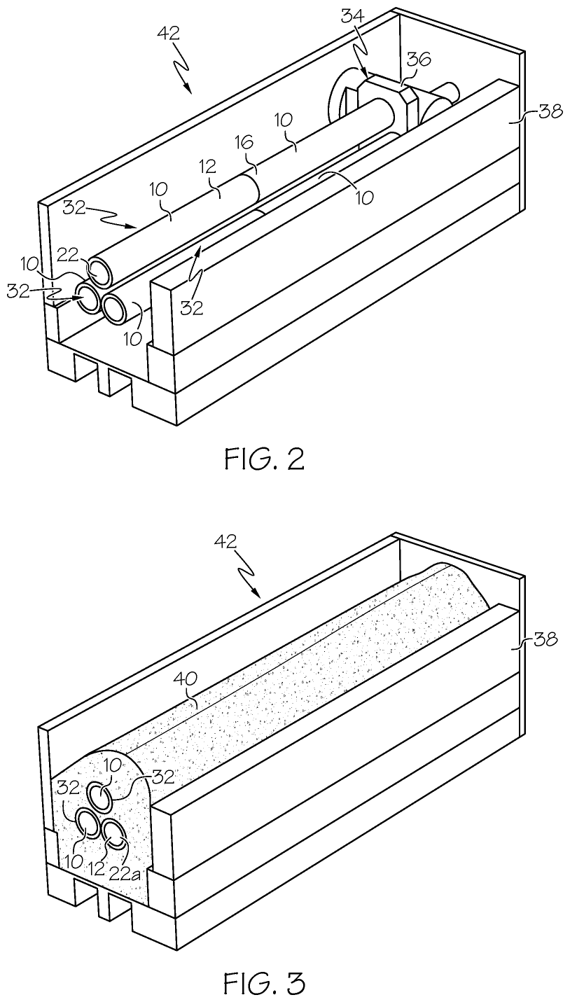

The cask 10 can be used for the graphitization of a payload material 19, such as carbon powder, in a longitudinal graphitization process. For example, the cask 10 can be used in conjunction with adjacent or supplemental casks 10 that are electrically coupled to the cask 10. A series of casks 10 can be coupled together or positioned adjacent to each other in this manner in an end-to-end manner to form a cask column 32, as shown in FIGS. 2 and 4. Two or more cask columns 32 can be arranged (side-by-side, and/or over-and-under, or the like) as shown in FIG. 2, or in other configurations as desired, and positioned in a cradle 38. The cask columns 32 can be coupled to and/or positioned in a frame 34 having two opposed bars 36, with a bar 36 located on each side of the cask column 32 (only one bar 36 is shown in FIG. 2). At least one of the bars 36 can be axially movable toward the other bar 36 to place the casks 10/cask columns 32 in compression, to take up any tolerances and ensure a strong mechanical and/or electrical connection, and to reduce contact resistance between the various components in the cask columns 32.

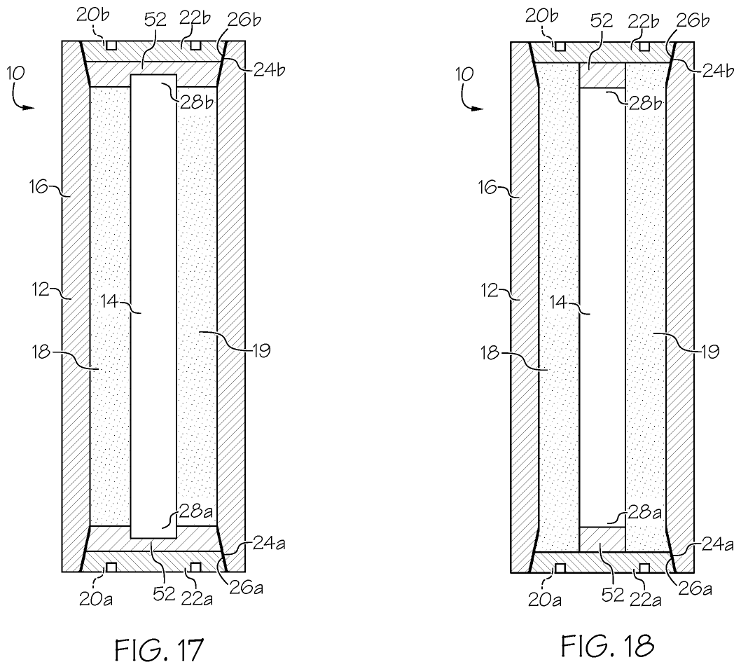

In one case, each cask 10 is pressed directly against any adjacent cask(s) 10, as shown on the right side of FIG. 4 (see also FIG. 14). In another case, an electrically conductive, compressible external spacer 29 made of, for example, flexible graphite in one case is positioned between two adjacent casks 10 as shown in the left side of FIG. 4. The spacer 29 can provide mechanical stress relief (e.g., from thermal expansion of the casks 10) while maintaining current flow through the casks 10. As shown in FIG. 3, the cask column(s) 32 can be covered by a bed of loose material 40 for thermal insulation and shielding from atmospheric oxygen, to provide a graphitization system 42. The casks 10/cask columns 32/filaments 14 can, in one case, be oriented in a horizontal or generally horizontal orientation (e.g. such that their respective central axes are so aligned) with respect to a gravitational frame of reference, but could be in differing positions if desired, including being vertically oriented (see FIGS. 17-19), oriented at an angle, etc.

Each hollow cask 10 can be filled with a starting payload material 19, such as a carbon powder material including carbon powders that, once graphitized, can be used as an active anode material in batteries, such as lithium-ion batteries. The payload material 19, when taking the form of carbon, can be nearly any form of carbon material, in one case having an average/median particle size between about 1 micrometer and about 100 micrometers. The timing and graphitization process for the payload material 19 can be affected by various qualities of the payload material 19, including density, thermal conductivity, specific resistivity, carbon yield, and particle sizing. The density and thermal conductivity of the starting payload material 19 strongly influence its heating rate, which may be taken into consideration in designing the cask 10 and filament 14. The electrical resistivity of the starting payload material 19 also influences its heating rate as well as the overall resistivity of the system. The carbon yield of the starting payload material 19 strongly influences the production of volatile products which may be generated during the graphitization process and is a factor in the environmental performance and safety of the system. Finally, the particle size of the payload material 19 strongly influences all of the above factors through a variety of mechanisms.

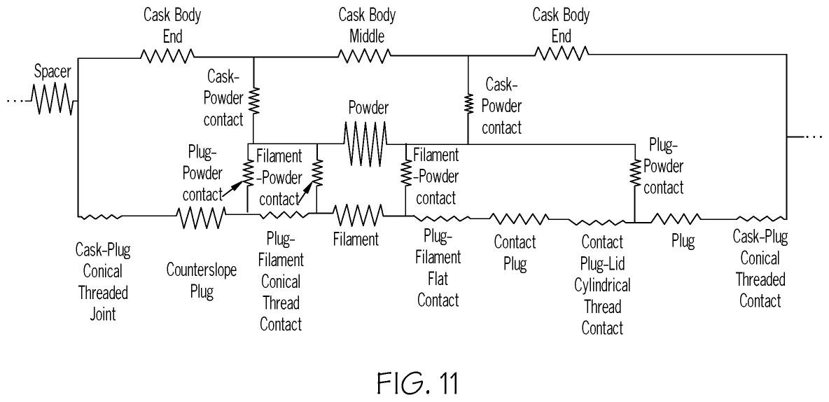

Once the payload material 19 is loaded in each cask 10 and the casks 10 are closed, electrical current is passed through the cask bodies 12, the filament 14, and to the extent possible, the payload material 19. As a practical matter however the current passing through the payload material 19, particularly at the beginning of the graphitization process, may be relatively low and is reflected by the high resistance shown in the circuit diagrams of FIGS. 5, 8, 11 and 13. The cask body 12 and filament 14 are thereby resistance heated due to the current passing therethrough, causing heat to transfer radially inwardly from the cask body 12 into the payload material 19, and also transfer radially outwardly from the filament 14 into the payload material 19, thereby raising the temperature of, and graphitizing, the payload material 19. In this embodiment, the payload material 19 may remain generally stationary/in place during the graphitization process, and in particular the payload material 19 does not pass from one open end 20a to or toward the other open end 20b, through the length of the cask 10.

The cask body 12 and filament 14 can be heated to achieve a predetermined temperature in the payload material 19 for a predetermined time. The payload material 19 may be desired to be heated at or to a target temperature of about least about 2,000° C. in one case, or at least about 2,800° C. in another case, or at least about 3,000° C. in another case, or at least about 3200° C. in yet another case, and the target temperature can be maintained for a hold time period of at least about 1 hour in one case, or at least about 3 hours in another case, or at least about 24 hours in yet another case. The target temperature can be maintained (for a hold time) for less than about 24 hours in one case, or less than about 6 hours in another case, or less than about 2 hours in another case, or less than about 0.5 hours in yet another case. The current system 42 can typically provide graphitization of the payload material 19 faster than a traditional Acheson type furnace.

In one example, the starting payload material 19 is heated to a temperature exceeding 2900° C. for a minimum of 10 hours, and in another example the payload material 19 is heated to a minimum of 3200° C. for between 0.5-4 hours. When the payload material 19 is desired to be used, after graphitization, as graphite anode powder (for example in a lithium-ion battery), payload material 19 may be desired to be heated sufficiently to induce graphite crystallization, which leads to a low d-spacing between graphite layer planes. For example, in one case this d-spacing is desired to fall below 3.363 angstroms, while in another it is desired to fall below 3.360 angstroms. When the system 42 is used to graphitize carbon, the finished payload product can be graphite powder having a particle size distribution of D10 5-20 μm; D50 10-30 μm; D90 20-40 μm with a D max of 90 μm, and average/median size of 10-30 μm.

As noted above, the payload material 19 can be relatively thermally and electrically insulating. Thus a limiting factor in determining how quickly the payload material 19 can be graphitized is the amount of time that it take the coolest part of the payload material 19 (e.g., typically the portion of the payload material 19 located furthest from a heat source to achieve the desired temperature for the desired time. Thus the presence of the filament 14, which can be located in the center of each cask 10/payload material 19, significantly reduces processing time required to raise all of the payload material 19 to a sufficiently high temperature to graphitize the payload material 19.

In the embodiment of FIGS. 1, 4 and 5 each plug 22a, 22b has a recess 30a, 30b on its axially inner end, where each recess 30a, 30b is sized to closely receive an end 28a, 28b of the filament 14 therein. In this embodiment, each plug 22a, 22b has an outer threaded surface 24a, 24b that is cylindrical (e.g. the threads are radially aligned). The cask body 12 has two corresponding inner cylindrical threaded surfaces 26a, 26b at opposed end thereof, each of which is configured to threadably engage the outer threaded surfaces 24a, 24b of the associated plug 22a, 22b. In addition, when the plugs 22a, 22b are threaded into place, the plugs 22a, 22b seal the inner cavity 18 of the cask body 12, and can also place the filament 14 in axial compression to ensure the filament 14 is retained in place, and to ensure good mechanical and electrical contact with the filament 14 and associated plugs 22a, 22b.

In this embodiment, each recess 30a, 30b is relatively smooth and unthreaded, but sized to closely receive the ends 28a, 28b of the filament 14 therein to provide good mechanical contact and reduce electrical resistance therebetween. Thus in one case each recess 30a, 30b is sized to have a diameter, surface area and/or perimeter length that is within at least about −1% in one case, and within about −0.1% in another case, of a corresponding diameter and/or surface area and/or perimeter length (circumference) of the associated end 28a, 28b of the filament 14. In this manner, when one or both plugs 22a, 22b are threaded into the cask body 12, solid mechanical and electrical contact is established between the cask body 12 and the plugs 22a, 22b, and also between the plugs 22a, 22b and the filament 14. The embodiment of FIGS. 1, 4 and 5 is also relatively easy to make and use.

In some cases, if desired, an internal spacer 31 (FIG. 4), made of the same materials and having the same properties of the spacers 29 as outlined above, can be positioned in each recess 30a, 30b. The internal spacers 31 can be physically and/or electrically positioned between the filament 14 and the associated plugs 22a, 22b. The internal spacers 31 can be compressible to accommodate any imprecise tolerances/fit between the plugs 22a, 22b and the filament 14. A spacer 31 is shown at each end 28a, 28b of the filament 14, but it should be understood that a spacer 31 can be used at only one, or neither, end 28a, 28b. It should also be noted that additional spacers 31 can, if desired, be used at nearly any contact surfaces between graphite components of the cask 10. Such spacers can also be used at the ends of the filaments 14 in the embodiments described below, but are not specifically shown/labelled in the drawings.

FIG. 5 is a circuit diagram representing a flow of current to and through the cask of FIG. 4. The higher resistance components/connections are shown with visually larger representations of resistance elements. As can be seen, moving in a left-to-right direction of FIG. 5, the spacer 29 offers a moderately high amount of resistance, and its resistance is typically desired to be minimized. For portions of the spacer 29 that are in direct contact with the cask body 12 (e.g. the radially outer portions of the spacer 29), as shown in the top line of FIG. 5, current then flows through the axially adjacent end of cask body 12, providing a moderately-low amount of resistance. Some current may flow to the powder/payload material 19 through the contact between the cask body 12 and the powder/payload material 19, offering a relatively low amount of resistance.

Continuing with the top line of FIG. 5, current flows through the middle portion of the cask body 12, offering a moderately-low amount of resistance. Further downstream (with reference to the current flow in this particular illustrative example), some current may flow to the powder/payload material 19 through the contact between the cask body 12 and the powder/payload material 19, offering a relatively low amount of resistance. Finally, continuing with the top line of FIG. 5, current flows through the downstream end of the cask body 12, offering a moderately-low amount of resistance.

As shown in the middle line of FIG. 5 the powder/payload material 19 offers a relatively high resistance, due to the inherent nature of the powder 19, at least at the beginning of the graphitization process.

Beginning on the left (upstream with reference to the current flow in this particular illustrative example) of the bottom line of FIG. 5, for electrical current that flows through the plug 22a, a low amount of resistance is provided at the contact between the cylindrical threaded surfaces 24a, 26a of the cask 12 and plug 22a of FIGS. 1 and 4. Current then flows through the plug 22a, which provides a moderately low amount of resistance due to the materials of which the plug 22a is made, and the orientation of those materials. Current then flows through the contact between the plug 22a and the spacer 31 and the contact between the spacer 31 and the filament 14, which offers a relatively low amount of resistance. Current then flows through the filament 14 and also through the powder/payload material 19 (via a moderately low resistance provided between the filament 14 and the powder/payload material 19). The filament 14 offers a moderately high resistance. Of course, the current flow through the filament 14 heats the filament 14 by Joule heating, which in turn heats the payload material 19 by heat radiating outwardly from the filament 14 as outlined above.

After current flows through the filament 14 along the bottom line of FIG. 5, some current may flow to/from the powder/payload material 19 via a moderately low contact resistance provided between the filament 14 and the powder 19. The current experiences a relatively low amount of resistance at the intersection of the filament 14 and the spacer 31, and between the spacer 31 and the plug 22b. The current then flows through the plug 22b, which offers a moderately low amount of resistance. The current then experiences a relatively low amount of resistance at the contact between the threaded surface 24b of the plug 22b and the threaded surface 26b of the cask body 12. Finally, the current flows to the adjacent cask 10 shown on the right in FIG. 4.

In one case, each resistance component in the system 42 (for example, in one case each resistive component shown by a resistance symbol in FIG. 5 (or in FIG. 8, 11 or 13), and/or other resistive components or arrangements not explicitly shown), excluding the resistance provided by the filament 14, the cask body 12, and the payload material 19 (which are desired to provide relatively high resistance and/or desired to be heated) provides less than 0.5% in one case, or less than 1% in another case of: 1) the total resistance of the system 42 in operation and/or 2) Joule heating of the system 42 in operation. In one case, each resistance component in the system 42, combined (again, excluding the resistance provided by the filament 14, the cask body 12, and the payload material 19) provides less than 10% in one case, or less than 5% in another case, or less than 3% in another case of: 1) the total resistance of the system 42 in operation and/or 2) Joule heating of the system 42 in operation. Conversely, in one case the filament 14, cask body 12 and payload material 19 provide at least 90% in one case, or at least 95% in another case, or at least about 97% in yet another case, of 1) the total resistance of the system 42 in operation and/or 2) Joule heating of the system 42 in operation. These parameters can apply in one case at the beginning of the graphitization process, and/or at the end of the graphitization process in another case, and/or any or all stages intermediate thereto.

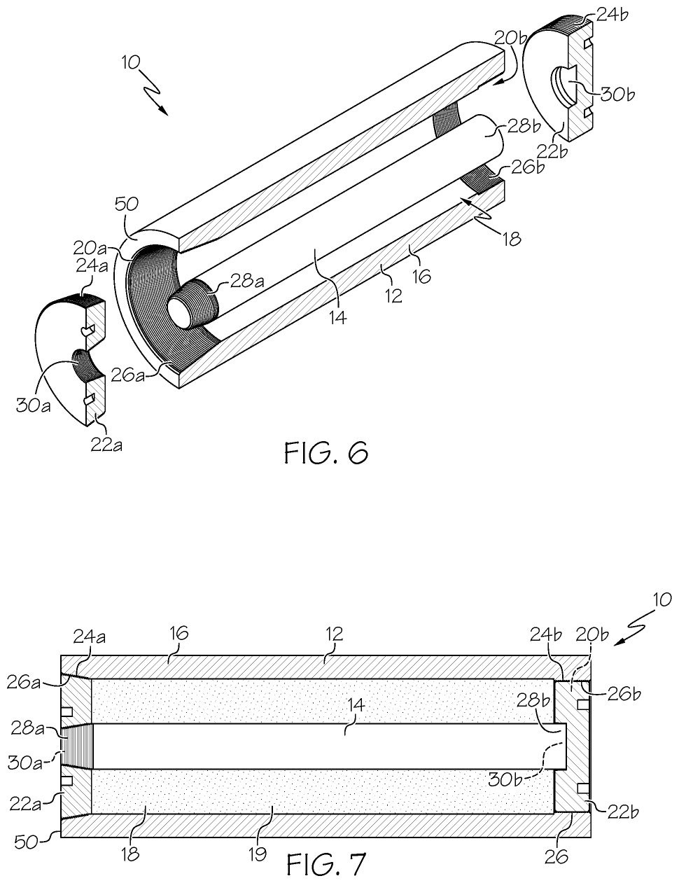

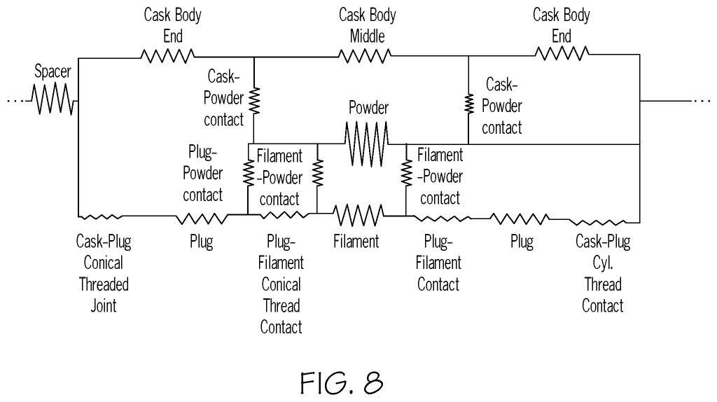

In the embodiment of FIGS. 6-8, the outer threaded surface 24a of the plug 22a is conical (e.g. the threads are aligned in a radially angled plane). The threaded surface 26a of the cask body 12 is correspondingly conical, and is configured to threadably engage the outer threaded surface 24a of the plug 22a. In this embodiment, the threaded surfaces 24a, 26a are angled radially inwardly, when moving from an outer axial surface in the axially inward direction, so that the plug 22a can be threaded into the cask body 12 from outside the cask body 12, providing case of assembly. The tapered threaded surfaces 24a, 26a provide increased mechanical contact between the plug 22a and the cask body 12, which reduces electrical contact resistance, and the tapered nature of the threaded surfaces 24a, 26a can also better accommodate and distribute compressive loads.

In addition, in this particular embodiment end 28a of the filament 14 has or takes the form of an outer conical threaded surface, and the corresponding recess 30a of plug 22a has an inner conical threaded surface 30a configured to threadably engage the threaded end 28a. In this embodiment, the threaded surfaces 28a, 30a are angled radially outwardly, when moving from an outer axial surface axially inwardly, so that the filament 14 can be threaded into the recess 30a from inside the cask body 12, providing case of assembly. The tapered threaded surfaces 28a, 30a provide increased mechanical contact between the filament 14 and the plug 22a, which reduces electrical contact resistance and can better accommodate and distribute compressive loads. In addition, in this embodiment the recess 30a extends entirely through the thickness of the associated plug 22a.

In this embodiment the outer threaded surface 24b of the other plug 22b is cylindrical, and the corresponding threaded surface 26b of the open end 20b of the cask body 12 is also cylindrical. In addition, as shown the end 28b of the filament 14 and the plug recess 30b are unthreaded, which results in an asymmetrical design for the cask 10. However if desired the threaded surfaces 24b/26b could be conical threaded surfaces, and/or the end 28b and plug recess 30b could be cylindrical threaded surfaces. In addition, it should be understood that the threaded surfaces 28a/30a and/or threaded surfaces 24a/26a in the embodiment of FIGS. 6-8, instead of being conical threaded surfaces, could be cylindrical threaded surfaces if desired. In general, conical threaded surfaces can provide reduced electrical resistance as compared to cylindrical threaded surfaces and/or can better accommodate and distribute compressive loads. However conical threaded surfaces can be more difficult to machine, and can be more difficult to thread during assembly of the mating threaded surfaces.

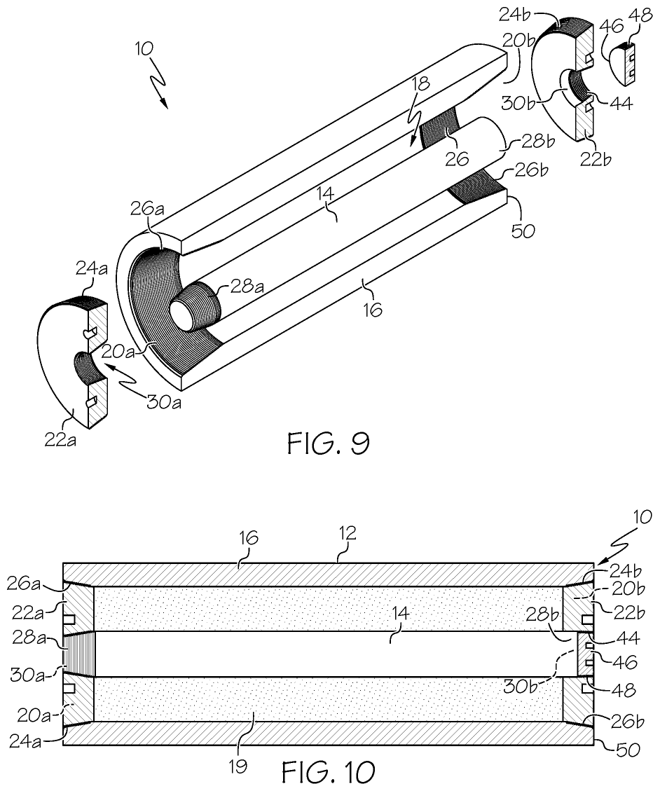

In the embodiment of FIGS. 9-11, each plug 22a, 22b has an outer threaded surface 24a, 24b that is conical and is configured to be threadably coupled to a corresponding conical threaded surface 26a, 26b of the cask body 12. In addition, in this embodiment the plug 22b/recess 30b includes an axially-outwardly located, inner cylindrical threaded surface 44 at least partially extending through a thickness thereof. The cask 10 further includes an insert 46, in the form of a solid disk or the like, with an outer threaded surface 48 configured to thread into the threaded surface 44 of plug 22b/recess 30b. The insert 46 can be made of the same materials as the cask body 12, filament 14 and/or plugs 22a, 22b as described above.

The insert 46, when threaded into place, engages the end 28b of the filament 14 and places the filament 14 in axial compression. Thus, in this embodiment, the compression applied to the filament 14 can be independent of the axial positioning of the plugs 22a, 22b within the open ends 20a, 20b of the cask 10, so that the cask 10 can be capped without over- or under-compressing the filament 14. If desired, the recess 30a of the other plug 22a can have a corresponding threaded surface that receives another insert (not shown) therein.

It is noted that the plugs 22a, 22b and/or inserts 46 tend to conduct electricity primarily in the radial direction due to their “puck”-like shape, and thus the plugs 22a, 22b and/or inserts 46 can be configured to have a low electrical resistance and/or coefficient of thermal expansion specifically in the radial direction. In contrast, the cask body 12 and/or filament 14 tend to conduct electricity primarily in the axial direction, since they are relatively long bodies that extend primarily in the axial direction. Thus the cask body 12 and/or filament 14 can be configured to have a low electrical resistance and/or coefficient of thermal expansion specifically in the axial direction. The relative specific resistance and other properties of the cask body 12 and filament 14 can also be selected to minimize temperature gradients, maximize the speed and energy-efficiency of graphitization, and improve the safety and stability of the system 42 and process.

The electrical resistivity of the material of the cask 10/cask body 12/filament 14 in one case is greater than about 2 micro-Ohm*meter and/or less than about 20 micro-Ohm*meter, and can be selected to properly balance current and power within the constraints of typical rectifier systems which provide the current to the cask 10. Compared to metals, the resistivity of the cask 10/cask body 12/filament 14 is relatively high, and thus requires higher voltage and lower current to sustain a given level of joule heating. If used in a high-voltage, high-current rectifier system, the range of resistivity of the cask 10/cask body 12/filament 14 can also be matched appropriately. The resistivity of cask body 12 and filament 14 may not be desired to be the same, but instead can be selected such that the joule heating of the cask body 12 and filament 14 is consistent throughout a heating cycle. For example, when the sidewall 16 of the cask body 12 is 3″ thick with a 24″ diameter, and the filament 14 has a 6″ diameter, the cask-filament ratio of specific resistance may be desired to fall between 1:1 and 1:2.

The coefficient of thermal expansion of the cask body 10/cask body 12/filament 14 may be desired to be the generally the same in order to reduce thermal stresses in the system 42. The cask 10/cask body 12/filament 14 should be made of materials having a strength sufficient that those components that it can self-support without breaking or damage, when in a sideways-cantilevered configuration when at rest.

In the embodiments of FIGS. 1 and 4-11 the filament 14 and the plugs 22a, 22b can be configured such that, when the plugs 22a, 22b are threadably coupled to the cask body 12 with the filament 14 therebetween and placed in compression, an axially outer end of each plug 22a, 22b is axially recessed relative to an associated end face 50 of the cask body 12 to provide an “inset” configuration, providing a gap 51 between immediately adjacent casks 10 as shown in FIG. 4. In this case the current can first flow into the cask body 12, and then pass through the plugs 22a, 22b and/or insert 46 before flowing through the filament 14. This embodiment can be used in situations where the filament 14 has a higher electrical resistivity than the cask body 12, such that the relatively lower electrical current flowing through the filament 14 can lead to relatively higher temperatures/heating. The recessed/inset design of FIGS. 1 and 4-11 thus provides a mechanism to control the current distribution through the cask 10. In addition, the recessed/inset configuration reduces compression forces applied to the plugs 22a, 22b, which can enable the plugs 22a, 22b to be made of a lower-strength and more inexpensive material, and may also extend the life of the plugs 22a, 22b.

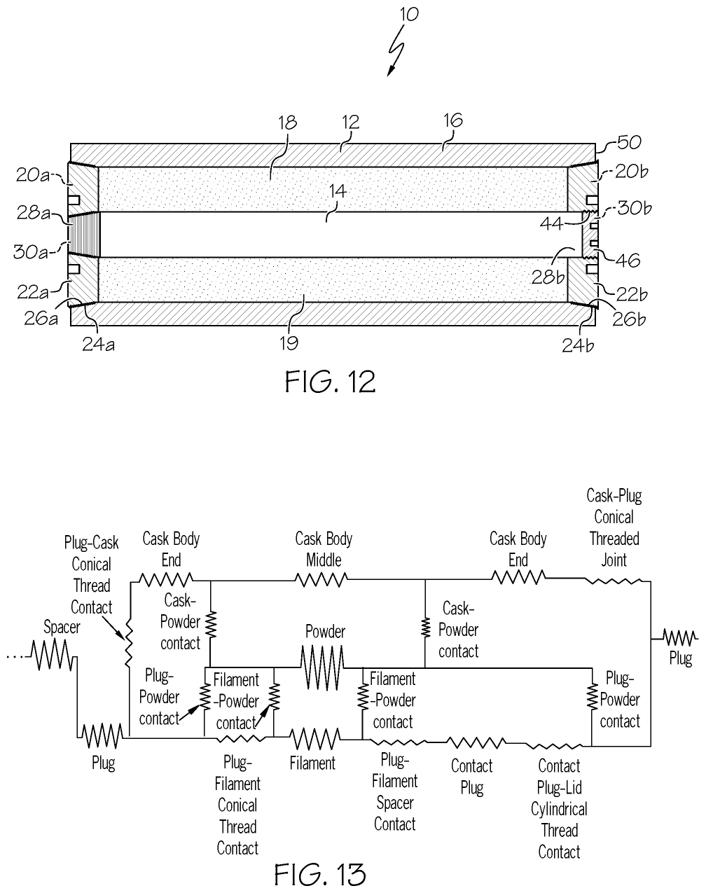

In an alternate embodiment, as shown in FIGS. 12-14, the filament 14 and the plugs 22a, 22b are configured such that, when the plugs 22a, 22b are threadably coupled to the cask body 12 with the filament 14 therebetween and placed in compression, an axially outer end of each plug 22a, 22b protrudes axially beyond an associated end face 50 of the cask body 12, to provide an “outset” configuration. This arrangement can help to provide a more effective heating of the payload material 19, as it can provide direct electrical connection between the plugs 22a, 22b, thus reducing resistance in the system 42 and reducing lost heat.

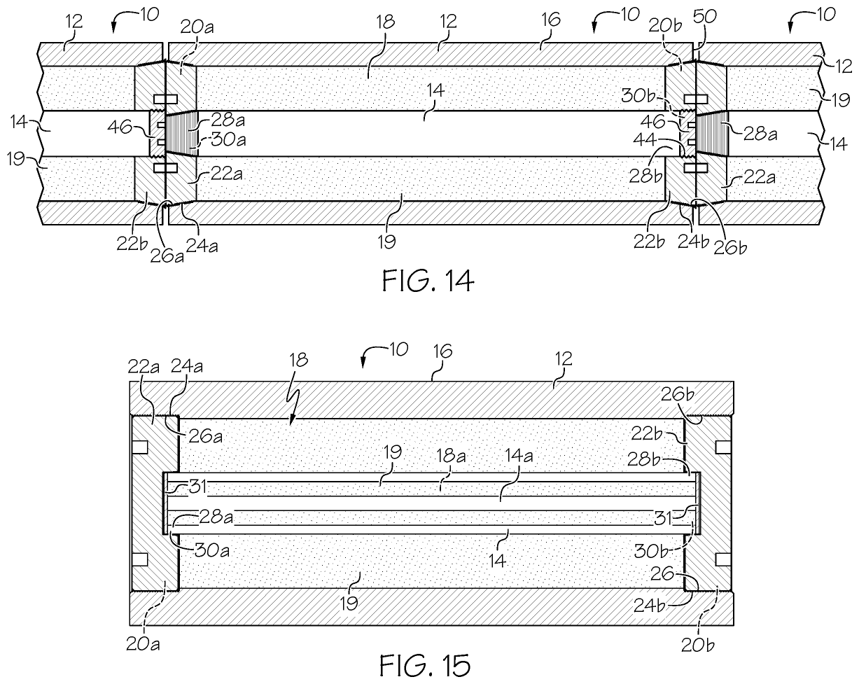

In some cases, and as shown in FIG. 15, if desired the filament 14 can itself be hollow, and include a sub-filament 14a positioned therein. In this case the filament 14 can act as a second cask body providing a second cavity 18a and be filled with a payload material 19 to increase the yield of the cask 10. The sub-filament 14a can be made of the same materials as the filament 14, and be positioned and retained in the filament 14 in any of the manners described and shown herein relating to the filament 14, or in other manners if desired.

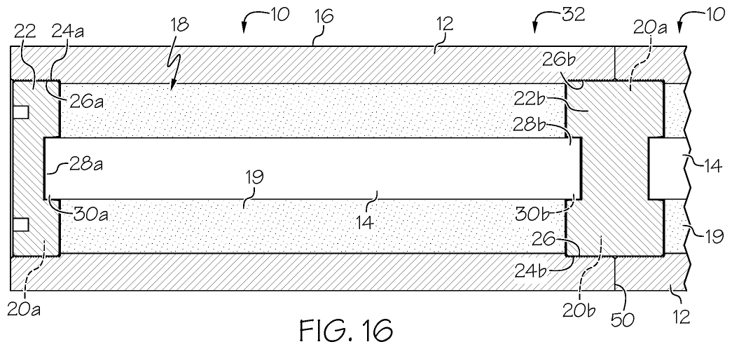

In yet another embodiment, as shown in FIG. 16, one or each plug 22a, 22b (plug 22b in the illustrated embodiment) can have a sufficient axial length, and have sufficient threads on the outer surface 24b thereof, such that the 22b can be simultaneously received in the open ends 20a, 20b of two adjacent casks 10. In this manner, the plug 22b, besides closing the open ends 20a, 20b of two associated casks 10, can also couple together the two adjacent casks 10. The plug 22b thereby operate as a double-threaded joint, and this configuration can help to provide electrical continuity between adjacent casks 10. In addition, the location, dimensions, and other qualities of the spacers 29, 31 can be adjusted as desired to control the resistance and other qualities of the system 42, and the current flowing through each cask 10.

FIG. 17 discloses an alternate embodiment wherein the filament 14 is spaced away in the axial direction, and not in direct contact with, one or each plug 22a, 22b. In this case, the plugs 22a, 22b need not includes the recesses 30a, 30b, and the plugs 22a, 22b and the filament 14 do not need to have any threaded surfaces thereon. Instead, a pad 52, or portion 52, of graphitized powder can be positioned axially between the filament 14 and the plugs 22a, 22b, and in direct contact with the filament 14 and the plugs 22a, 22b, to thereby electrically couple the filament 14 and the plugs 22a, 22b.

Each pad 52 can be made of graphitized material, in one case having the same properties as the powder 19/payload material 19 outlined above, after graphitization. The pads 52 can be more electrically conductive than the powder 19/payload material, at least prior to graphitization of the powder 19/payload material. However, the pads 52 can be made of nearly any carbonaceous material that in one case is loose, powdered and/or particle and/or flake form, such as coke or graphite, including expanded graphite flakes that have been calendared to a predetermined thickness, where the material can in some cases be compressed to form the pad 52 in a cylindrical shape that can retain its dimensions in the absence of any surrounding supporting structure.

Each pad 52 can have a thickness of greater than 1% in one case, or greater than 5% in another case of the axial length of the cask 10/cask body 12, and/or less than 25% in one case, and less than 15% in another case, of the length of the cask 10/cask body 12. In the embodiment of FIG. 17, each pad 52 covers the entire surface area of the associated plug 22a, 22b (e.g. each pad 52 has a surface area and/or diameter (or effective diameter)) at its axially outer end that matches the surface area/diameter/effective diameter of the axially inner surface of the associated adjacent plug 22a, 22b. In addition, although FIG. 17 shows the axial ends 28a, 28b of the filament 14 abutting against the end surface of the pads 52, the axial ends 28a, 28b of the filament 14 can be at least partially “embedded” in one or both pads 52 such that at least part of the curved outer surface of each filament 14 is also in contact with each pad 52.

In order to form the cask arrangement of FIG. 17, the cask body 12 with the plug 22a can be provided in positioned in a vertical arrangement as shown. A bottom pad 52 can then be formed by placing the material of the pad 52 in the cavity 18, positioning the material of the bottom pad 52 on top of the plug 22a. The material of the bottom pad 52 can be loosely placed in the cavity 18 and then compacted, or in another case a pre-compacted material of the pad 52 can be placed as a unit in the bottom of the cavity 18. The filament 14 can then be positioned in the center of the cavity 18 and on top of the bottom pad 52. The payload material 19 can the be positioned about the filament 14, filling the cavity 18. The top pad 52 can then be formed by placing the material of the top pad 52 in the cavity 18, on top of the filament 14 and on top of the payload material 19. The plug 22b can then be coupled to the cask body 12 and secured in place.

Thus, it can be seen that in the embodiment of FIG. 17, the filament 14 is not directly in contact with and/or is not constrained by and/or is not received in and/or is not directly mechanically coupled to the plugs 22a, 22b, unlike the embodiments of FIGS. 1 and 4-16. The filament 14 of the embodiment of FIG. 17 can thus be considered to be a “floating” filament 14. The floating nature of the filament 14 enables the payload material 19 to support and position the filament 14, without any threaded contact, and without applying any pressure or compression to the filament 14. This simplifies installation and removal of the filament 14 since, for example, threaded and unthreading of the filament 14 is not required. In addition, the loading and unloading of the payload material 19 is simplified since the filament 14 can be easily removed to provide full access to the payload material 19. Moreover, stress concentrations applied to the roots of any threaded surfaces are eliminated. In addition, formation/manufacturing of the cask body 12 is simplified since machining operations are reduced. Finally, unlike the threaded designs, the filament is not able to be positioned in an unsupported, cantilever configuration (e.g. when the cask 10 is in a horizontal configurated, without any payload material 19 in the cask 10) which can cause damage to the filament 14 and/or plugs 22a, 22b.

On the other hand, the threaded embodiments can provide certain advantages over the floating filament embodiment. In particular, threaded connections can provide lower resistance as compared to the use of the pads 52, which can reduce the amount of internal heating (e.g. can reduce heat loss). In addition, the threaded filament design provides a fixed geometry, which eliminates any undesired shifting in position of the filament. The use of threaded and unthreaded embodiments provides options to optimize the alignment, stability and performance of the system.

As noted above, in the embodiment of FIG. 17 each pad 52 extends the entire diameter/surface area of the associated plug 22a, 22b. In an alternate embodiment, as shown in FIG. 18, the pad 52 extends less than the entire diameter/surface area of the associated plug 22a, 22b. In particular in the embodiment of FIG. 18 each pad 52 covers the entire surface area of the axial end surface of the filament 14 (e.g. each pad 52 has a diameter (or effective diameter) at its axially inner end matching that of the axially outer end surface of the filament 14). In this case the payload material 19 extends to, and is in direct contact with, one or each plug 22a, 22b. As can be seen, in the embodiment of FIG. 18, the pads 52 can have a longer axial length, as compared to the pads 52 of FIG. 17. The larger cross sectional area provided by the pad 52 of FIG. 17 provides low resistance path for current to flow from the plugs 22a, 22b to the filament 14, cither directly through the pad 52/filament 14 contact, and/or through the payload material 19/filament 14 contact. The smaller cross sectional area provided by the pad 52 of FIG. 18 can be compensated for somewhat by extending its axial length, which enables more current to enter the pad 52 in the radial direction, through the payload material 19, to provide a low-resistance connection to the filament 14.

The embodiment of FIG. 18, as compared to the embodiment of FIG. 17 can process higher volumes of the payload material 19. Conversely however the embodiment of FIG. 18 may not provide as effective heating of the filament 14 as the embodiment of FIG. 17.

The embodiment of FIG. 18 can also be more complicated to load/assemble than the embodiment of FIG. 17 and may require the use of a sleeve to retain the payload material in place. In particular, in order to form the cask 10 of FIG. 18, the cask body 12 with the plug 22a can be provided in positioned in a vertical arrangement as shown. A sleeve (not shown) having a diameter matching that of the pad 52 and filament 14, can then be inserted into the cavity 18. The bottom pad 52 can then be formed by placing the material of the pad 52 in the sleeve, and compacting the pad material, if desired. The filament 14 can then be positioned in the sleeve, on top of the bottom pad 52. Next the top pad 52 can be formed by placing the material of the top pad 52 in the sleeve, and compacting the material, if desired. The payload material 19 can the be positioned about the sleeve, filling the remaining space in the cavity 18. The sleeve is then removed, and the plug 22b can then be coupled to the cask body 12 and secured in place, leading to the configuration shown in FIG. 18.

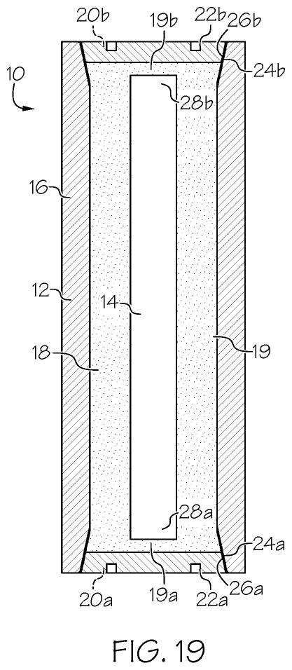

In another embodiment shown in FIG. 19, the top and bottom pads 52 are omitted, and instead payload material 19a, 19b is positioned adjacent to the ends 28a, 28b of the filament 14, and positioned directly axially between the filament 14 and the plugs 22a, 22b. While the use of a floating filament 14 without any pads 52, and the use of payload material 19 instead, may provide reduced performance due to reduced conductivity of the payload material 19 as compared to the pads 52, such an embodiment is easy to implement, and reduces the types and amount of different materials that must be stored on-site.

The casks 10 and configurations disclosed herein can provide low contact resistance between the plugs 22a, 22b and the cask body 12, and between the plugs 22a, 22b and the filament 14 to ensure that the (functionally and/or physically) parallel electrically conducting structures (cask body 12 and filament 14) both have a similar current density during use/operation. In addition, the contact surfaces between the cask body 12 and plugs 22a, 22b (and plugs 22a, 22b and filament 14) can be designed to provide good mechanical and electrical contact to reduce electrical resistance, which improves performance and reduces any hot spots created by high contact resistance. Finally, the various designs disclosed herein provide a robust system that is easy to assemble and disassemble, which can be useful since the casks 10 are typically desired to be loaded and unloaded many times over their useful life.

Having described the invention in detail and by reference to certain embodiments thereof, it will be apparent that modifications and variations are possible without departing from the scope of the invention which is defined in the appended claims.

What is claimed is:

1. A system for graphitization of carbon powder, the system including a cask comprising:
a cask body made of a carbonaceous material and a binder, the cask body having a cavity; and
a filament made of a carbonaceous material and a binder, wherein the filament is configured to be positioned in the cavity and aligned with the cask body.

2. The system of claim 1 wherein the system is configured for longitudinal graphitization of graphite powder, wherein the cask body and the filament both have an electrical resistivity of between about 2 micro-Ohm*meter and about 20 micro-Ohm*meter and have the ability to withstand temperatures of at least about 2000 degrees Celsius, wherein the carbonaceous material of the cask body is coke, and wherein the carbonaceous material of the filament is coke.

3. The system of claim 1 wherein the cask body is generally tubular, wherein the filament extends at least about 80% of a length of the cask body, wherein the filament is aligned with a central axis of the cask body, wherein the filament is spaced away from sidewalls of the cask body, wherein the filament is removable from the cask body, and wherein the filament does not extend axially beyond the cask body.

4. The system of claim 1 wherein the cask includes a pair of plugs at either end thereof, wherein each plug is configured to be coupled to and cover an associated open end of the cask body, and wherein each plug is configured to be electrically coupled to an associated end of the filament.

5. The system of claim 4 wherein at least one plug has an outer cylindrical threaded surface, wherein the cask body includes an inner cylindrical threaded surface configured to threadably engage the outer threaded surface of the at least one plug.

6. The system of claim 4 wherein at least one plug has an outer conical threaded surface, wherein the cask body includes an inner conical threaded surface configured to threadably engage the outer threaded surface of the at least one plug.

7. The system of claim 4 wherein each plug is configured to be threadably coupled to cask body, and wherein the filament and at least one plug are configured such that, when the at least one plug is threadably coupled to the cask body with the filament placed in compression therebetween, an axially outer end of the at least one plug extends axially beyond an associated end face of the cask body.

8. The system of claim 4 wherein each plug is configured to be threadably coupled to cask body, and wherein the filament and at least one plug are configured such that, when the at least one plug is threadably coupled to the cask body with the filament placed in compression therebetween, an axially outer end of the at least one plug is axially recessed relative to an associated end face of the cask body.

9. The system of claim 4 wherein each plug is configured to be threadably coupled to the cask body, and wherein at least one plug includes a recess configured to closely receive the associated end of the filament therein.

10. The system of claim 9 wherein the recess of the at least one plug is unthreaded.

11. The system of claim 9 wherein the recess of the at least one plug has an inner threaded surface configured to threadably engage an threaded outer surface of the filament.

12. The system of claim 9 wherein the recess of the at least one plug extends through an entire thickness of the at least one plug.

13. The system of claim 12 further comprising an insert configured to be threadably inserted into the recess of the at least one plug and to engage the associated end of the filament when the recess receives the associated end of the filament therein.

14. The system of claim 1 wherein the filament has a cavity therein, and wherein the system further includes a sub-filament made of a carbonaceous material and a binder, wherein the sub-filament is aligned with the filament and positioned in the cavity of the filament, and generally spaced away from the filament.

15. The system of claim 1 wherein the cask include at least one plug, wherein the at least one plug is configured to be threadably coupled to an associated end of the cask body, and wherein the plug is also configured to be simultaneously threadably coupled to an end of an adjacent cask body.

16. The system of claim 1 further comprising a supplemental cask axially aligned with the cask and in electrical communication with the cask, wherein the cask and the supplemental cask are in direct contact with each other and are axially compressed together, wherein the cask and the supplemental cask are positioned in a bed of thermally insulating loose material, and wherein the cask is filled with loose or powdered amorphous carbon payload material.

17. The system of claim 1 wherein the cask includes a pair of plugs at either end thereof, wherein each plug is configured to be coupled to and cover an associated open end of the cask body, and wherein the filament is spaced apart from each plug.

18. The system of claim 17 further comprising a pair of pads, each pad being located between and in contact with the cask and an associated, adjacent plug.

19. The system of claim 17 wherein each pad is made of carbonaceous material.

20. The system of claim 17 wherein each pad has a surface area at an axially outer end corresponding to a surface area of an axially inner surface of the associated plug.

21. The system of claim 17 wherein each pad has a surface area at an axially inner end corresponding to a surface area of an associated axial end surface of the filament.

22. The system of claim 17 wherein the cask is filled with loose or powdered amorphous carbon payload material, and wherein the payload material is positioned directly axially between the filament and each plug.

23. A system for use in graphitization of carbon powder, the system including a cask comprising:
a cask body made of a carbonaceous material and a binder, the cask body having a cavity;
a filament made of a carbonaceous material and a binder, wherein the filament is configured to be positioned in the cavity and aligned with the cask body; and
a pair of plugs at either end of the cask body, wherein each plug is configured to be coupled to and cover an associated open end of the cask body, and wherein each plug is configured to be electrically coupled to an associated end of the filament.

24. A method comprising:
accessing a cask including a cask body made of a carbonaceous material and a binder, the cask body having an inner cavity, the cask including a filament made of a carbonaceous material and a binder, the filament being positioned in the inner cavity;
loading loose or powdered amorphous carbon payload material into the inner cavity; and
passing electrical current through the cask body and the filament for a predetermined time to heat the cask body, the filament and the payload material sufficient to cause graphitization of the payload material.

25. The method of claim 24 wherein, during the passing step, the filament, cask body and the payload material together provide at least 90% of Joule heating of the cask.
